(19) United States
(12) Patent Application Publication
(10) Pub. No.: US 2026/0340739 A1
(43) Pub. Date: Oct. 29, 2026

(54) SYSTEMS AND METHODS FOR PREDICTIVE DOCUMENT ANALYSIS AND MANIPULATION

(71) Applicant: INTUIT INC., Mountain View, CA (US)

(72) Inventors: John SAMUEL, Bangalore (IN); Isham RAJGARIAH, Bangalore (IN); Pradeep Kurunimakkil LXMINARAYANA, Bangalore (IN)

(73) Assignee: INTUIT INC., Mountain View, CA (US)

(21) Appl. No.: 19/193,622

(22) Filed: Apr. 29, 2025

(51) Int. Cl. G06Q 40/10; G06F 16/93; G06F 40/279; G06Q 50/26

(52) U.S. Cl. CPC G06Q 40/10; G06F 16/93; G06Q 50/26; G06F 40/279

(57) ABSTRACT

A system and method are provided for predicting audit likelihoods using LLMs.

### BACKGROUND OF THE DISCLOSURE

The Internal Revenue Service (IRS) has the authority to audit any tax returns, whether of individuals or businesses. Once discrepancies are found, the IRS typically sends an audit notice to the relevant individual or business. Audits can typically be quite tedious, expensive, and cumbersome to deal with. Non-compliance can lead to costly penalties and legal disputes. However, currently existing software programs and predictive tools are limited in how they assist users in avoiding audits, which is undesirable.

### BRIEF DESCRIPTION OF THE FIGURES

FIG. 1 is a block diagram of an example system for predicting audit likelihoods using LLMs according to example embodiments of the present disclosure.

FIGS. 2A-2B are flowcharts of example processes for predicting audit likelihoods using LLMs according to example embodiments of the present disclosure.

FIG. 3 is a flowchart of an example process for simulating a scenario according to example embodiments of the present disclosure.

FIGS. 4A-14B show example outputs from various modules of the system of FIG. 1 according to example embodiments of the present disclosure.

FIG. 15 is a diagram of an example computing device or server device.

FIG. 16 is another example of a computing device.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the disclosure are directed to system and methods for predicting audit likelihoods using LLMs. In particular, the disclosed system and methods can analyze tax documents provided by a user and estimate a likelihood that the user experiences an audit after their taxes are filed. For example, the disclosed system and methods can use a combination of standard and fine-tuned LLM models to analyze tax returns comprehensively, identify irregularities or deviations from IRS norms, and assess the likelihood of audit based on historical and real-time tax return data. In some embodiments, the disclosed system and methods can detect potential risks and red flags and provide accompanying explanations. Moreover, the disclosed system and methods can highlight areas of concern within a provided tax return and data supporting the concern. Finally, the disclosed system and methods can offer tailored advice and recommendations on addressing the identified issues and concerns, including standardized documentation and supporting evidence suggestions.

In addition, embodiments of the disclosure relate to system and methods for providing a scenario simulation tool, where users can alter the tax return data or provide scenarios to see how changes might affect the potential audit risk. Based on the user input, which can simply be provided in natural language within a user interface, the disclosed system and methods can analyze the new request/new data and generate the detailed analysis with the explanation of potential red flags and impacts related to the audit.

The disclosed system and methods can offer actionable insights that enable individuals and business to proactively optimize their filings, minimize the risk of non-compliance, and avoid costly penalties and legal disputes, which can ultimately foster a smoother and more transparent relationship with tax authorities. In addition, the disclosed system and methods can provide users with a clear and easily understandable summary of audit risk factors and offer recommendations for rectifying potential issues before filing. Such an approach can empower taxpayers to address discrepancies, minimize risks, and make more informed decisions, thereby preventing unexpected audits and ensuring compliance. Moreover, the disclosed system and methods can regularly update the database and models with newly implemented IRS rules, tax laws, and audit data to maintain accuracy and relevance. In some embodiments, the system can be further be configured to mask personally identifiable information (PII) to ensure robust data protection and compliance with privacy regulations.

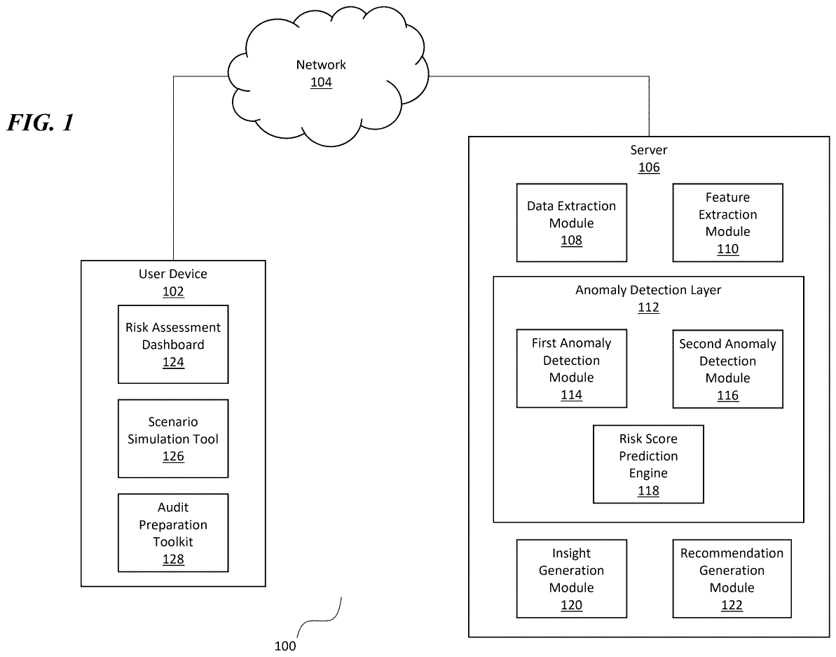

FIG. 1 is a block diagram of an example system 100 for providing personalized tax recommendations using LLMs according to example embodiments of the present disclosure. The system 100 can include one or more user devices 102 (generally referred to herein as a “user device 102” or collectively referred to herein as “user devices 102”) that can access a server 106 via a network 104 to facilitate communication and engage with a tax software architecture. In some embodiments, the software architecture can allow a user (e.g., a taxpayer, tax professional, business owner, etc.) to perform various tax-related tasks. In particular, the server 106 can enable a user to engage with an audit prediction tool. The server 106 can, via its various modules, analyze a tax return and assess the likelihood of audit based on historical and real-time tax return data. In some embodiments, the software architecture can be an external, customer-facing service in which customers of a platform can provide requests and prompts and provide their own documents, such as tax or other financial documents. In some embodiments, the system 100 can include any number of user devices 102. For example, for a financial or accounting platform or other website that may offer services to users, there may be an extensive userbase with thousands or even millions of users that connect to the system 100 via their user devices 102.

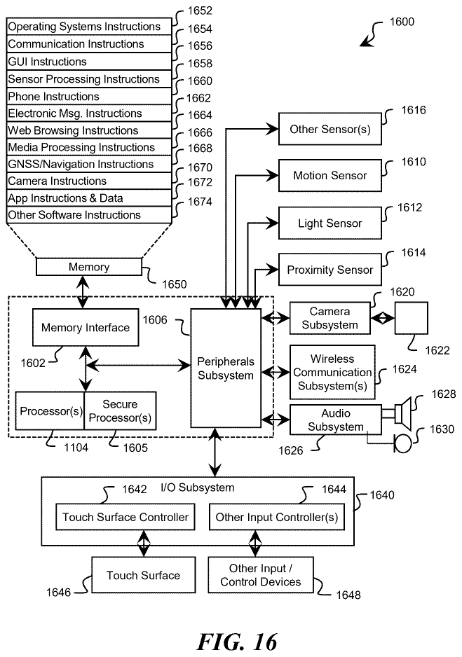

A user device 102 can include one or more computing devices capable of receiving user input, transmitting and/or receiving data via the network 104, and or communicating with the server 106. In some embodiments, a user device 102 can be a conventional computer system, such as a desktop or laptop computer. Alternatively, a user device 102 can be a device having computer functionality, such as a personal digital assistant (PDA), a mobile telephone, a smartphone, or other suitable device. In some embodiments, a user device 102 can be the same as or similar to the computing device 1600 described below with respect to FIG. 16.

The network 104 can include one or more wide areas networks (WANs), metropolitan area networks (MANs), local area networks (LANs), personal area networks (PANs), or any combination of these networks. The network 104 can include a combination of one or more types of networks, such as Internet, intranet, Ethernet, twisted-pair, coaxial cable, fiber optic, cellular, satellite, IEEE 801.11, terrestrial, and/or other types of wired or wireless networks. The network 104 can also use standard communication technologies and/or protocols.

The server 106 may include any combination of one or more of web servers, mainframe computers, general-purpose computers, personal computers, or other types of computing devices. The server 106 may represent distributed servers that are remotely located and communicate over a communications network, or over a dedicated network such as a local area network (LAN). The server 106 may also include one or more back-end servers for carrying out one or more aspects of the present disclosure.

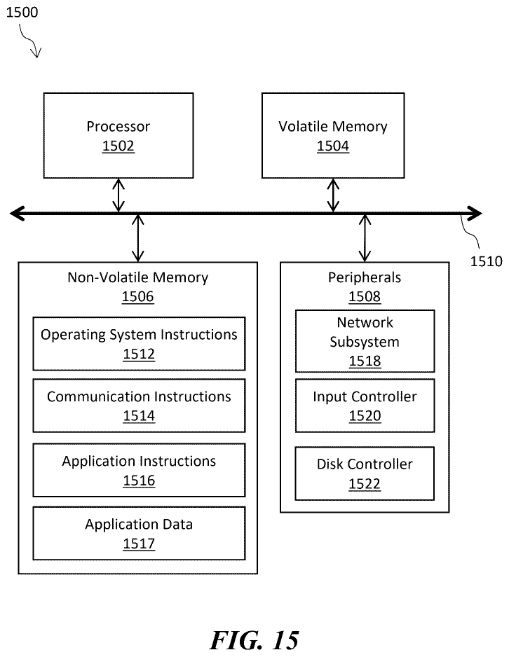

In some embodiments, the server 106 may be the same as or similar to server 1500 described below with respect to FIG. 15.

As shown in FIG. 1, the user device 102 can include a risk assessment dashboard 124, a scenario simulation tool 126, and an audit preparation toolkit 128.

In some embodiments, the risk assessment module 124 can enable a user to view a detailed analysis of their tax return along with various identified patterns and associated data-backed explanations.

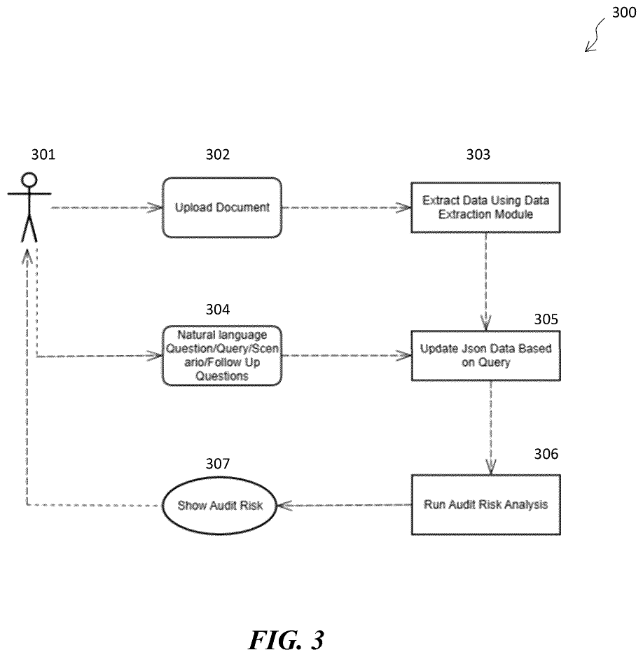

In some embodiments, the scenario simulation tool 126 can enable a user to explore how an audit risk might change based on changes to their tax return data. For example, in some embodiments, the scenario simulation tool 126 can enable a user to alter the tax return data directly. In addition, the scenario simulation tool 126 can enable a user to utilize a natural language query to make such an exploration. For example, in the case of a natural language query being provided to understand how changes might affect the user's potential risk, the system can utilize generative AI (e.g., one of the LLM modules that are part of the server 106) to generate the updated data and pass it to the anomaly detection layer 112 for analysis. Based on the changed data, new insights can be generated and the changes in potential risks can be viewed in real-time. Additional details related to the scenario simulation tool 126 are discussed in relation to FIG. 3.

In some embodiments, the audit preparation toolkit 128 can enable users to view recommendations and actions that can be taken (e.g., as determined by the various modules of the server 106) to minimize their audit risk. In addition, the audit preparation toolkit 128 can provide the relevant documents and supporting evidence for the suggestions and recommended actions.

As shown in FIG. 1, the server 106 can include a data extraction module 108, a feature extraction module 110, an anomaly detection layer 112, an insight generation module 120, and a recommendation generation module 122. In addition, the anomaly detection layer 112 can include a first anomaly detection module 114, a second anomaly detection module 116, and a risk score prediction engine 118.

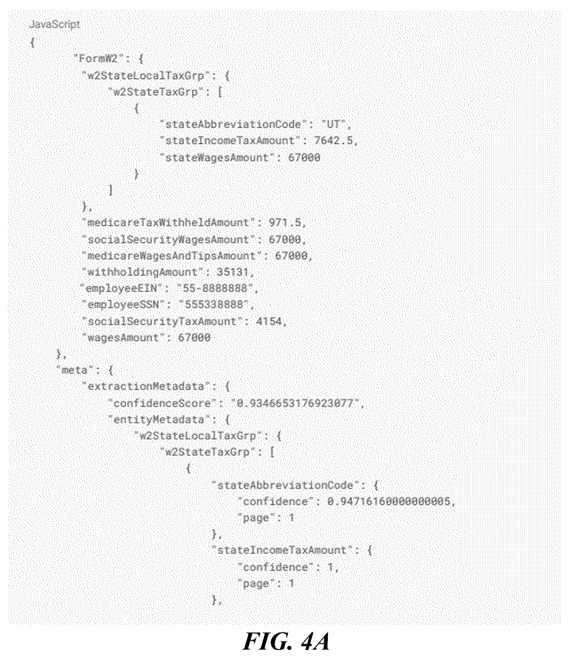

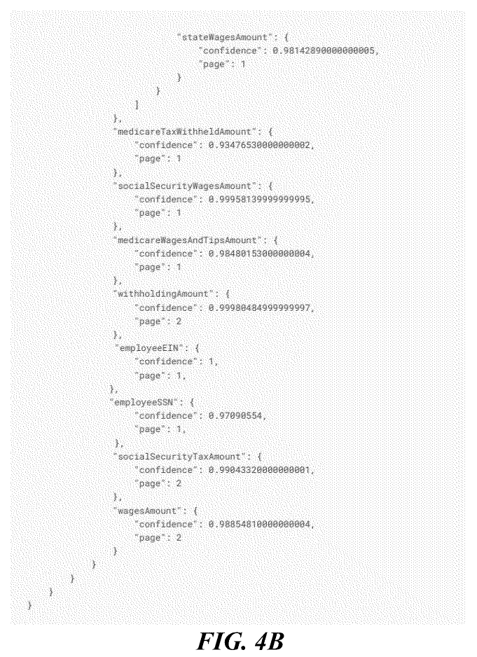

In some embodiments, the data extraction module 108 can be configured to receive a tax return document from the user device 102. In some embodiments, the tax return document can include one or more of historical and/or current year tax return data for a taxpayer in any format (e.g., image, text document, PDFs, etc.). In some embodiments, the data extraction module 108 can be configured to extract one or more field and value pairs (also referred to herein as “field-value pairs”) from the received documents. In some embodiments, the data extraction module 108 can be configured to leverage a combination of generative Al, optical character recognition (OCR) techniques, and natural language processing (NLP) techniques. In some embodiments, the data extraction module 108 can extract all field-value pairs from the tax return and output the extracted data in a structured format, such as a JSON (see FIGS. 4A-4B). For example, examples of field-value pairs can include a “state income tax amount” field and associated value “$7,642.5,” a “social security wages amount” or a “social security wages amount” field and associated value of “67000.”

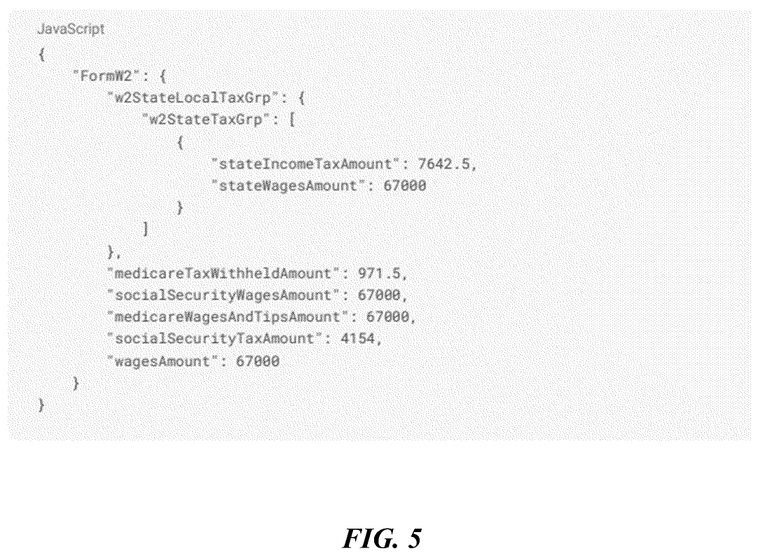

In some embodiments, the feature extraction module 110 can be configured to analyze the field-value pairs extracted by the data extraction module 108 and identify fields that are most relevant to audits. For example, these can include income types, deductions, credits, mortgages, losses, itemized deductions, crypto deductions, donations, etc., although these are not limiting and are merely exemplary in nature. In some embodiments, the feature extraction module 110 can have knowledge of fields that are important to predict audit risks, although this knowledge can be modified at any time. In some embodiments, the feature extraction module 110 can be configured to discard other fields and outputs and thereby output a structured format (e.g., a JSON) having fields identified as being relevant (see FIG. 5). For example, an example of a relevant field-value pair taken from the output of the data extraction module 108 (as shown in FIGS. 4A-4B) can include a “state income tax amount” field and associated value “$7,642.5” and other field-value pairs.

In some embodiments, the anomaly detection layer 112 can be configured to, via its three components, predict an audit likelihood for the received documents. In some embodiments, the anomaly detection layer 112 can include an LLM, such as GPT-3, -3.5, -4, PaLM-E, Ernie Bot, LLaMa, and others, and the various modules and engines contained therein can be configured to utilize the LLM to perform various tasks. In some embodiments, the LLM can include various transformed-based models trained on vast corpuses of data that utilize an underlying neural network. In addition, the LLM of the first anomaly detection module 114 can be finetuned with various historical tax return data such that it can detect patterns that differ from previous year tax returns to the current year, thus potentially causing an audit of the tax return. The LLM of the anomaly detection layer 112 can be finetuned on historically flagged audit patterns, in addition to tax rules and laws. Moreover, the finetuning can be performed periodically for any updates in laws or new patterns.

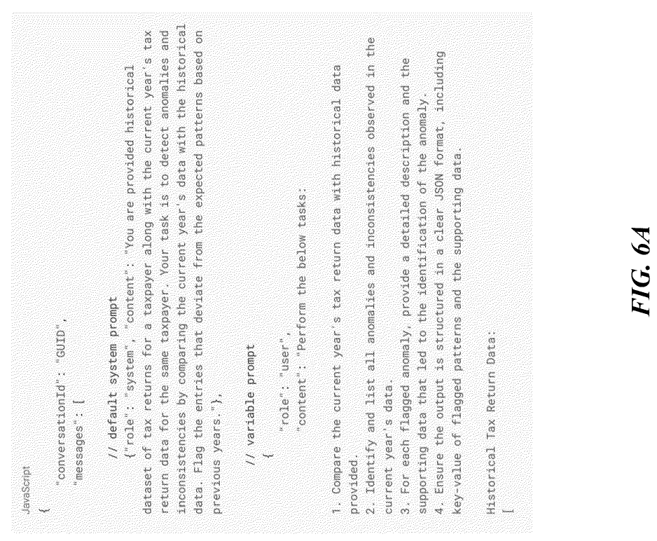

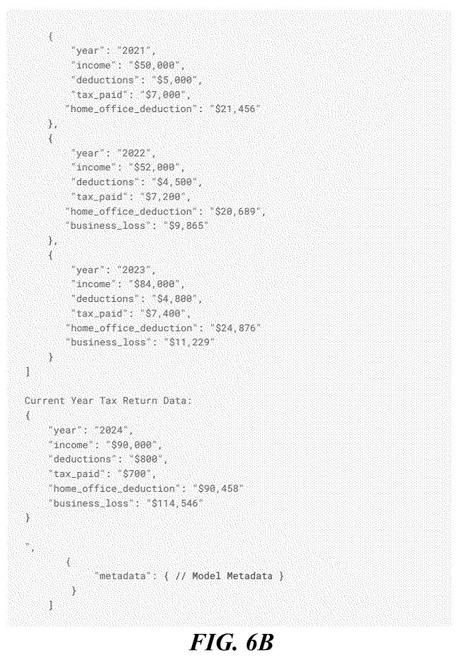

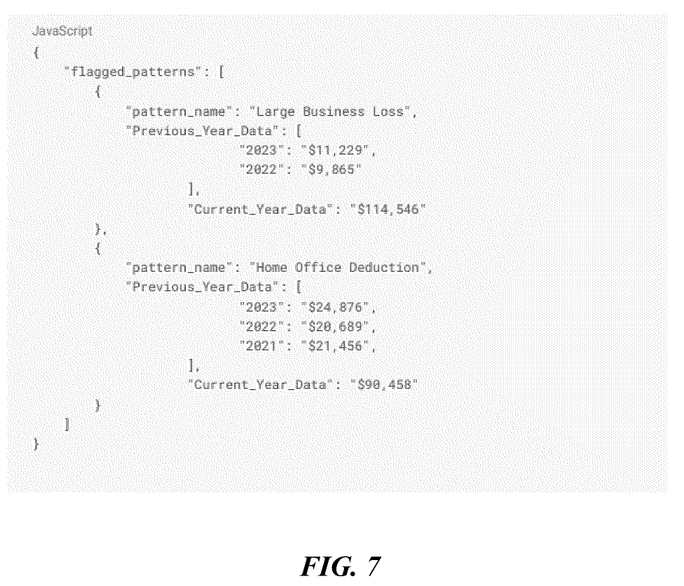

In some embodiments, the first anomaly detection module 114 can be configured to detect inconsistencies and anomalies of the received tax return documents compared to historical data for the associated taxpayer. In some embodiments, the first anomaly detection module 114 can receive a prompt (see FIGS. 6A-6B) and flag entries that deviate from expected patterns (i.e., a “historical deviation pattern”). In some embodiments, the first anomaly detection module 114 can output a map of the flagged patterns and supporting data for each identified flag. An example output from the first anomaly detection module 114 is shown in FIG. 7, which shows various flagged historical patterns in a structured format. An example flagged pattern can be a “large business loss”, where previous losses were $11,229 in 2023 and $9,865 in 2022 and a current loss is $114,546.

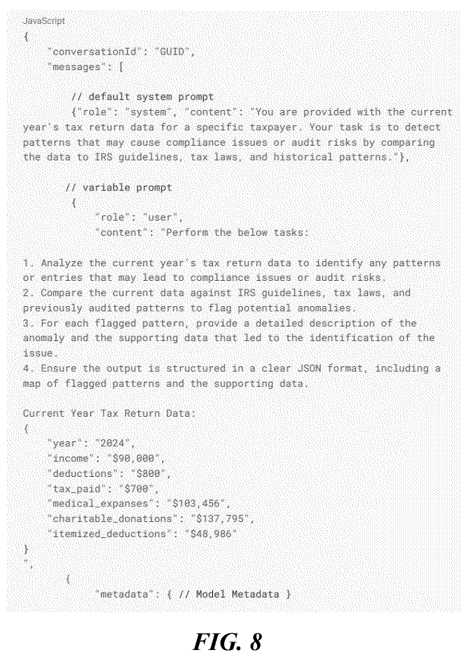

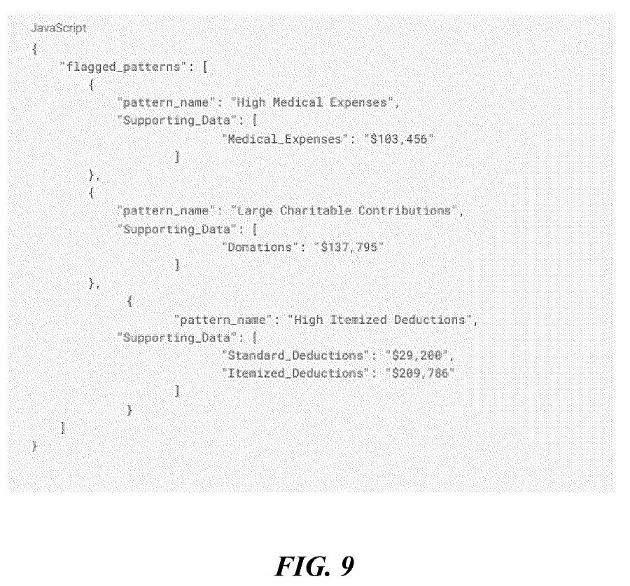

In some embodiments, the second anomaly detection module 116 can be configured to detect various patterns in a tax return that can cause compliance issues or audit risks. In some embodiments, the second anomaly detection module 116 can receive a prompt (FIG. 8) employ a rule-based approach to identifying anomalies and audit risks. For example, in some embodiments, the second anomaly detection module 116 can utilize the LLM discussed in relation to the anomaly detection layer 112. In some embodiments, the second anomaly detection module 116 can output a map of the flagged patterns and the supporting data for each identified flag. An example output from the second anomaly detection module 116 is shown in FIG. 9, which shows various flagged patterns in a structured format. An example flagged audit pattern can be a “high medical expense” or $103,456.

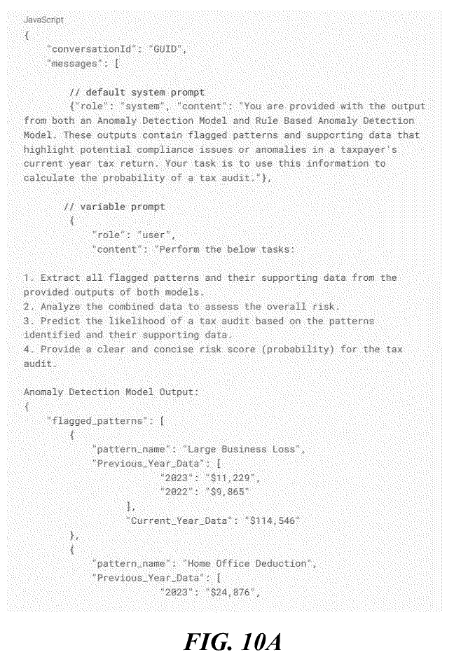

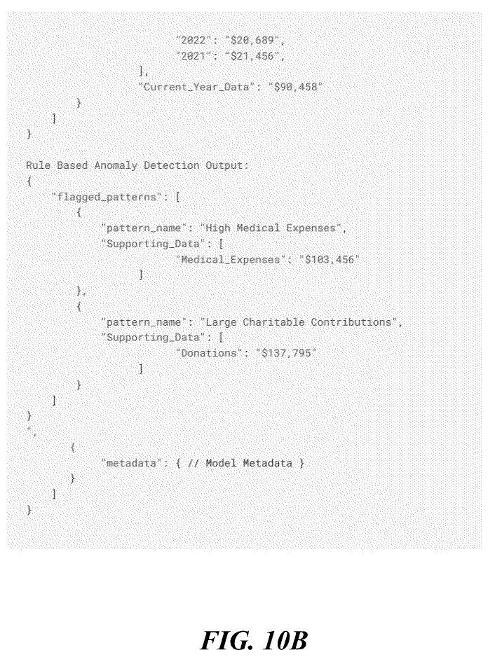

In some embodiments, the risk score prediction engine 118 can be configured to receive the outputs from the first and second anomaly detection modules 114 and 116 (e.g., a prompt as shown in FIGS. 10A-10B) and compute a tax audit probability value. For example, in some embodiments, the risk score prediction engine 118 can utilize the LLM discussed in relation to the anomaly detection layer 112. The risk score prediction engine 118 can extract the flagged patterns and supporting data received from the first and second anomaly detection modules 114 and 116 and predict the likelihood of tax audit. In some embodiments, the likelihood can be a percentage value or decimal number between 0 and 1, although this is merely an example and various scoring ranges could be utilized.

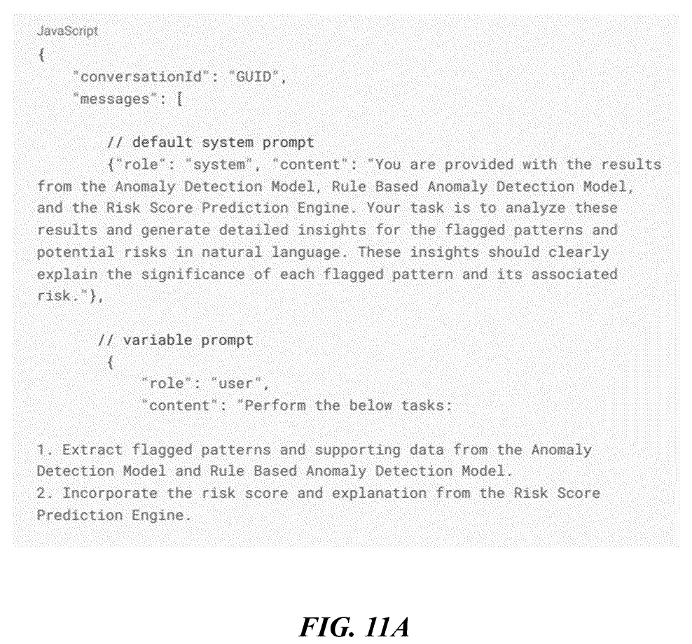

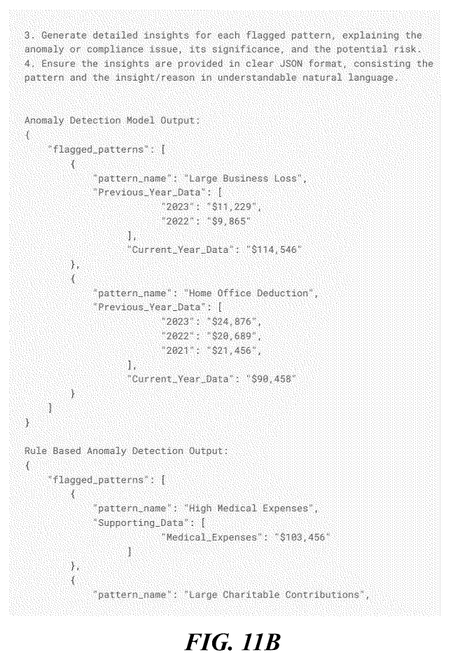

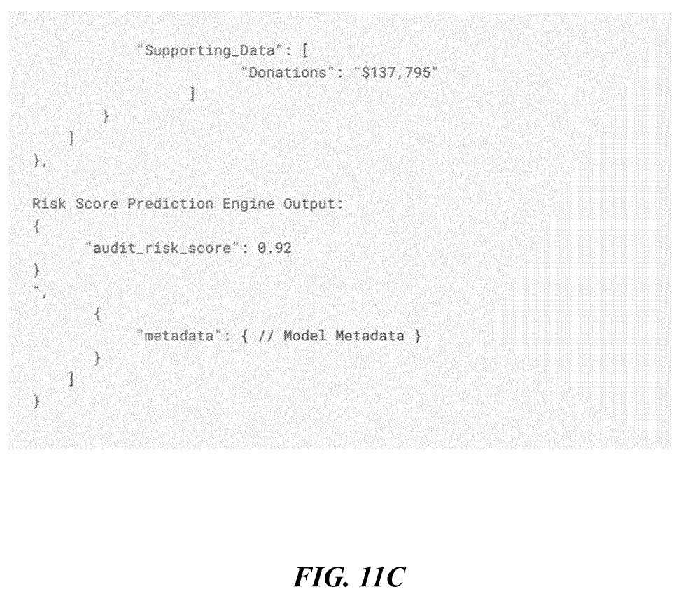

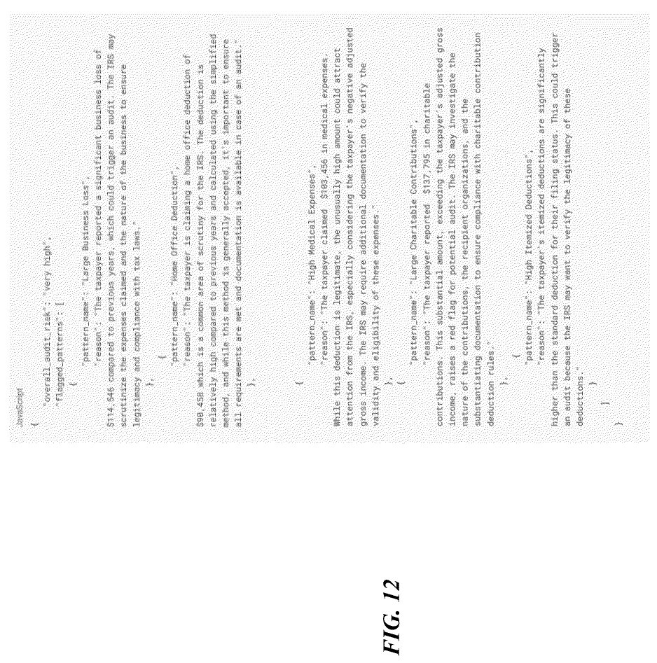

In some embodiments, the insight generation module 120 can be configured to analyze the flagged patterns and the audit likelihood to generate a natural language insight (e.g., an explanation) therefrom. In some embodiments, the insight generation module 120 can receive a prompt (see FIGS. 11A-C) be configured to use a second LLM to generate its insights, such as GPT-3, -3.5, -4, PaLM-E, Ernie Bot, LLaMa, and others. In some embodiments, the second LLM can include various transformed-based models trained on vast corpuses of data that utilize an underlying neural network. In some embodiments, the second LLM can be finetuned on expert tasks and advices, such as those most commonly undertaken post audit. Such data can be collected by historical mappings; in addition, expert review and recommendations can be periodically added to keep the model updated. In some embodiments, the second LLM can also be finetuned on supported documentation utilized in conjunction with various audit patterns. An example insight is shown in FIG. 12. For the exemplary flagged historical pattern of a large business loss as described in relation to FIG. 7, the generated insight can be “The taxpayer reported a significant business loss of $114,546 compared to previous years, which could trigger an audit. The IRS may scrutinize the expenses claimed and the nature of the business to ensure legitimacy and compliance with tax laws.”

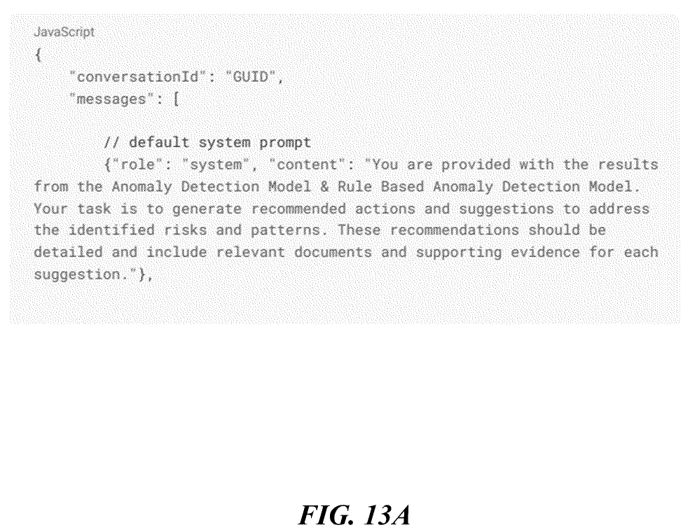

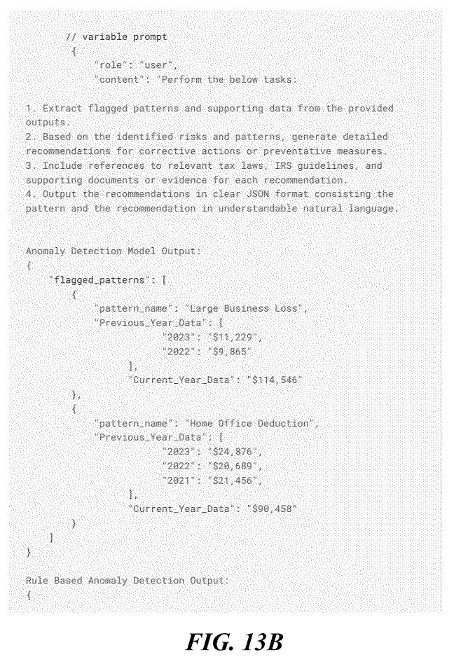

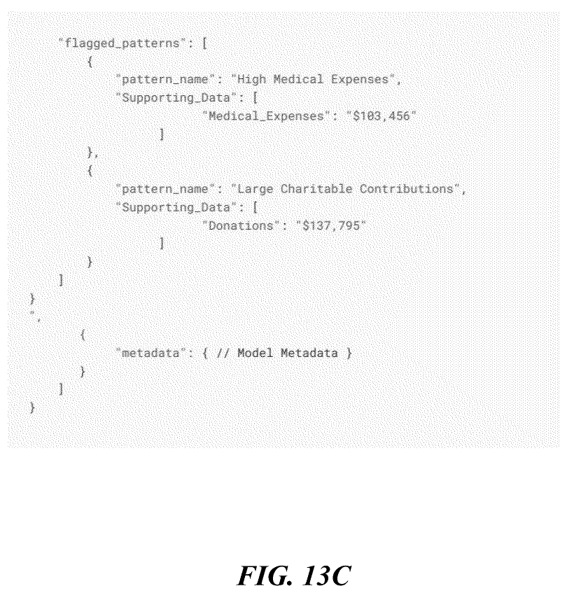

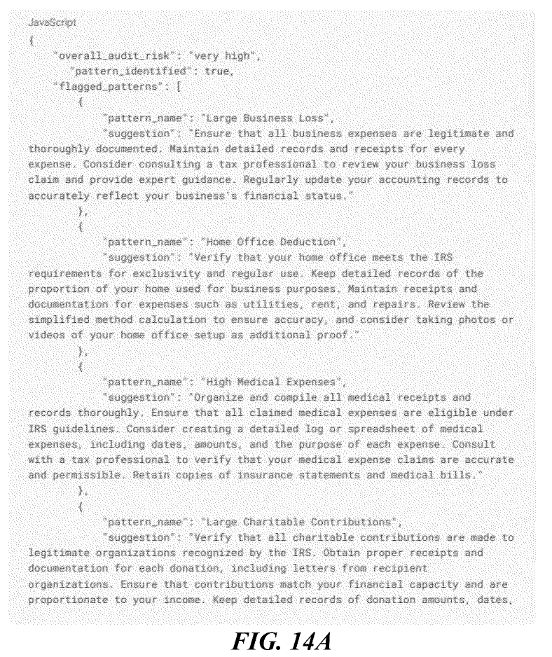

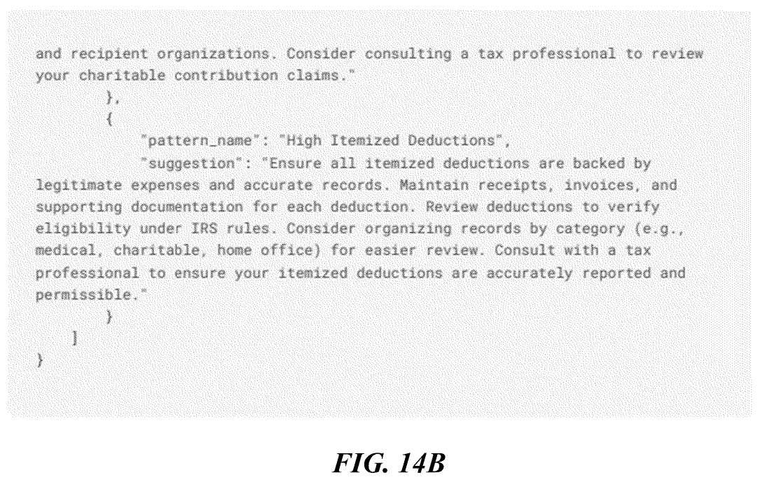

In some embodiments, the recommendation generation module 122 can be configured to analyze the flagged patterns and the audit likelihood to generate a natural language recommendation or action item therefrom. In some embodiments, the recommendation generation module 122 can receive a prompt (see FIGS. 13A-13C) be configured to use the second LLM (discussed in relation to the insight generation module 120) to generate its insights. An example insight is shown in FIGS. 14A-14B. For the exemplary flagged historical pattern of a large business loss as described in relation to FIG. 7, the generated recommendation can be “Ensure that all business expenses are legitimate and thoroughly documented. Maintain detailed records and receipts for every expense. Consider consulting a tax professional to review your business loss claim and provide expert guidance. Regularly update your accounting records to accurately reflect your business's financial status.”

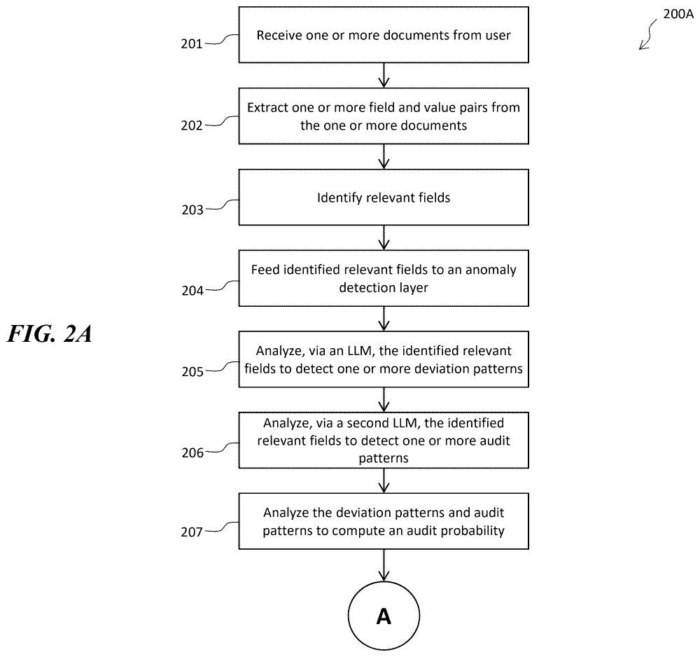

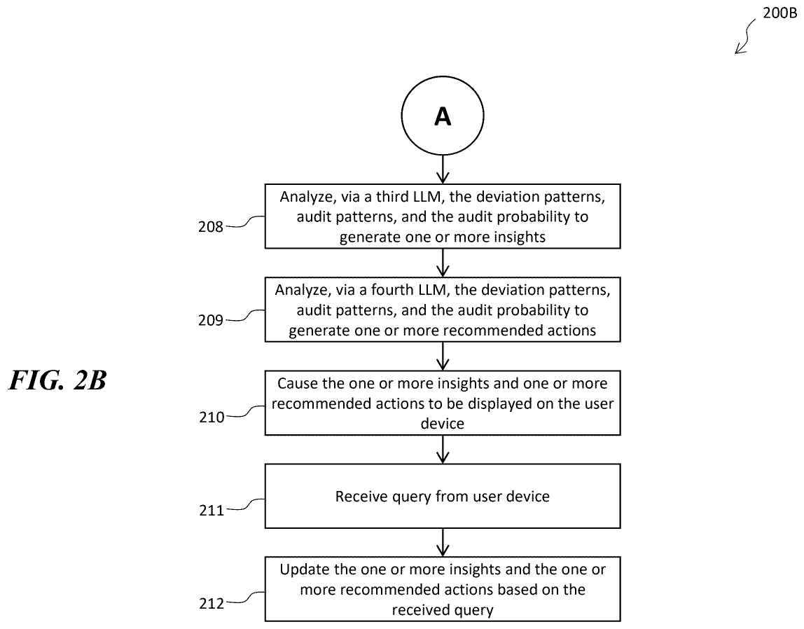

FIGS. 2A-2B are flowcharts of example processes 200A-B for predicting audit likelihoods using LLMs according to example embodiments of the present disclosure. In some embodiments, the processes 200A-B can be performed by the server 106 and its various modules within the system 100 of FIG. 1.

At block 201, the process 200A can include receiving one or more documents from a user device 102. In some embodiments, the documents can be received by the data extraction module 108. In some embodiments, the tax return document can include one or more of historical and/or current year tax return data for a taxpayer in any format (e.g., image, text document, PDFs, etc.). At block 202, the process 200A can include extracting, via the data extraction module 108, one or more field-value pairs from the received one or more documents. In some embodiments, the extracting can be performed using a combination of generative Al, OCR techniques, and NLP techniques. In some embodiments, the data extraction module 108 can extract all field-value pairs from the tax return and output the extracted data in a structured format, such as a JSON (see FIGS. 4A-4B).

At block 203, the process 200A can include identifying, via the feature extraction module 110 one or more relevant fields within the field-value pairs extracted pairs from the data extraction module 108. For example, the feature extraction module 110 can identify fields that are most relevant to audits. In some embodiments, the feature extraction module 110 can utilize a rule-based model that is trained on tax terms and fields and their respective weights for audit processes. In some embodiments, the feature extraction module 110 can filter the relevant fields from the fields extracted by the data extraction module 108. For example, these can include income types, deductions, credits, mortgages, losses, itemized deductions, crypto deductions, donations, etc., although these are not limiting and are merely exemplary in nature. In some embodiments, identifying the one or more relevant fields can also include discarding other fields and outputs and thereby outputting a structured format (e.g., a JSON) having fields identified as being relevant (see FIG. 5).

At block 204, the process 200A can include feeding the identified relevant fields to an anomaly detection layer 112. At block 205, the process 200A can include analyzing, via an LLM of the anomaly detection layer 112, the identified relevant fields to detect one or more deviation patterns (an example prompt is shown in FIGS. 6A-6B). In some embodiments, the analyzing can include comparing the identified relevant field-value pairs with historical data for the associated taxpayer. In some embodiments, the first anomaly detection module 114 can output a map of the flagged patterns and supporting data for each identified flag (see FIG. 7).

At block 206, the process 200A can include analyzing, via the LLM of the anomaly detection layer 112, the identified relevant fields to detect one or more audit patterns (an example prompt is shown in FIG. 8). In some embodiments, the analyzing can include employing a rule-based approach to identifying anomalies and other audit risks within the identified relevant field-value pairs. In some embodiments, the second anomaly detection module 116 can output a map of the flagged patterns and the supporting data for each identified audit pattern (see FIG. 9).

At block 207, the process 200A can include analyzing, via the risk score prediction engine 118 and the LLM of the anomaly detection layer 112, the identified deviation patterns and audit patterns to compute an audit probability (an example prompt is shown in FIGS. 10A-10B). In some embodiments, the analyzing can include extracting the flagged patterns and supporting data received from the first and second anomaly detection modules 114 and 116 and predicting the likelihood of tax audit therefrom.

In some embodiments, at block 208, the process 200B can include analyzing, via a second LLM and the insight generation module 120, the deviation patterns, audit patterns, and the audit probability to generate one or more insights (an example prompt is shown in FIGS. 11A-11C). In some embodiments, generating the insight can include generating a natural language insight or explanation of the flagged patterns (an example output is shown in FIG. 12). At block 209, the process 200B can include analyzing, via the second LLM and the recommendation generation module 122, the deviation patterns, audit patterns, and the audit probability to generate one or more recommended actions (an example prompt is shown in FIGS. 13A-13C). In some embodiments, generating the recommended actions can include generating a natural language action item or recommendation related to remedying the risks of the flagged patterns (an example output is shown in FIGS. 14A-14B).

At block 210, the process 200B can include causing at least one of the one or more insights and the one or more recommended actions to be displayed on the user device, such as via the risk assessment dashboard 124 and the audit preparation toolkit 128. At block 211, the process 200B can include receiving a query from the user device 102. For example, the user can alter data of the documents originally received at block 201. In another example, the user can submit a natural language query regarding what would happen if certain tax data were changed. At block 212, the process 200B can include updating at least one of the one or more insights and the one or more recommended actions based on the received query.

FIG. 3 is a flowchart of an example process 300 for simulating a scenario according to example embodiments of the present disclosure. At block 302, the user 301 can upload one or more documents and, at block 303, the data extraction module 108 can extract one field-value pairs from the tax return and output the extracted data in a structured format. In addition, at block 304, the user can submit a natural language query via their user device as a follow-up to previous analysis. For example, for an example query of “In the current year if I offset my last year capital loss of $20000 with the current year business profit, is there any audit risk involved with it?”, a follow up question could be “Are there specific regulations on how much capital loss I can claim in one year without increasing my audit risk?” or “What supporting documents do I need to validate my claimed capital losses?” In another example where the query is “What is the audit risk if I claim a deduction for unreimbursed work expenses of $3000?”, a follow up question can be “Is there any impact of frequent changes in unreimbursed work expenses year-over-year?” In yet another example where the query is “Can I claim two dependents on my tax return?”, a follow up question can be “What if I claim 5 or more dependents on my tax return?”

At block 305, the data extraction module 108 can update the output generated at block 303 based on the query and/or follow up question received from the user 301. At block 306, the audit risk analysis can be performed again (see FIGS. 2A-2B) and, at block 307, the audit risk analysis can be displayed to the user 301.

FIG. 15 is a diagram of an example computing device or server device. Server 1500 can implement various features and processes as described herein. Server 1500 can be implemented on any electronic device that runs software applications derived from complied instructions, including without limitation personal computers, servers, smart phones, media players, electronic tablets, game consoles, email devices, etc. In some implementations, server 1500 can include one or more processors 1502, volatile memory 1504, non-volatile memory 1506, and one or more peripherals 1508. These components can be interconnected by one or more computer buses 1510.

Processor(s) 1502 can use any known processor technology, including but not limited to graphics processors and multi-core processors. Suitable processors for the execution of a program of instructions can include, by way of example, both general and special purpose microprocessors, and the sole processor or one of multiple processors or cores, of any kind of computer. Bus 1510 can be any known internal or external bus technology, including but not limited to ISA, EISA, PCI, PCI Express, USB, Serial ATA, or FireWire. Volatile memory 1504 can include, for example, SDRAM. Processor 1502 can receive instructions and data from a read-only memory or a random access memory or both. Essential elements of a computer can include a processor for executing instructions and one or more memories for storing instructions and data.

Non-volatile memory 1506 can include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 1506 can store various computer instructions including operating system instructions 1512, communication instructions 1514, application instructions 1516, and application data 1517. Operating system instructions 1512 can include instructions for implementing an operating system (e.g., Mac OS®, Windows®, or Linux). The operating system can be multi-user, multiprocessing, multitasking, multithreading, real-time, and the like. Communication instructions 1514 can include network communications instructions, for example, software for implementing communication protocols, such as TCP/IP, HTTP, Ethernet, telephony, etc. Application instructions 1516 can include instructions for various applications. Application data 1517 can include data corresponding to the applications.

Peripherals 1508 can be included within server device 1500 or operatively coupled to communicate with server device 1500. Peripherals 1508 can include, for example, network subsystem 1518, input controller 1520, and disk controller 1522. Network subsystem 1518 can include, for example, an Ethernet of WiFi adapter. Input controller 1520 can be any known input device technology, including but not limited to a keyboard (including a virtual keyboard), mouse, track ball, and touch-sensitive pad or display. Disk controller 1522 can include one or more mass storage devices for storing data files; such devices include magnetic disks, such as internal hard disks and removable disks; magneto-optical disks; and optical disks.

FIG. 16 is another example of a computing device. The illustrative user device 1600 can include a memory interface 1602, one or more data processors, image processors, central processing units 1604, and or secure processing units 1605, and peripherals subsystem 1606. Memory interface 1602, one or more central processing units 1604 and or secure processing units 1605, and or peripherals subsystem 1606 can be separate components or can be integrated in one or more integrated circuits. The various components in user device 1600 can be coupled by one or more communication buses or signal lines.

Sensors, devices, and subsystems can be coupled to peripherals subsystem 1606 to facilitate multiple functionalities. For example, motion sensor 1610, light sensor 1612, and proximity sensor 1614 can be coupled to peripherals subsystem 1606 to facilitate orientation, lighting, and proximity functions. Other sensors 1616 can also be connected to peripherals subsystem 1606, such as a global navigation satellite system (GNSS) (e.g., GPS receiver), a temperature sensor, a biometric sensor, magnetometer, or other sensing device, to facilitate related functionalities.

Camera subsystem 1620 and optical sensor 1622, e.g., a charged coupled device (CCD) or a complementary metal-oxide semiconductor (CMOS) optical sensor, can be utilized to facilitate camera functions, such as recording photographs and video clips. Camera subsystem 1620 and optical sensor 1622 can be used to collect images of a user to be used during authentication of a user, e.g., by performing facial recognition analysis.

Communication functions can be facilitated through one or more wired and or wireless communication subsystems 1624, which can include radio frequency receivers and transmitters and or optical (e.g., infrared) receivers and transmitters. For example, the Bluetooth (e.g., Bluetooth low energy (BTLE)) and or WiFi communications described herein can be handled by wireless communication subsystems 1624. The specific design and implementation of communication subsystems 1624 can depend on the communication network(s) over which the user device 1600 is intended to operate. For example, user device 1600 can include communication subsystems 1624 designed to operate over a GSM network, a GPRS network, an EDGE network, a WiFi or WiMax network, and a Bluetooth™ network. For example, wireless communication subsystems 1624 can include hosting protocols such that device 1600 can be configured as a base station for other wireless devices and or to provide a WiFi service.

Audio subsystem 1626 can be coupled to speaker 1628 and microphone 1630 to facilitate voice-enabled functions, such as speaker recognition, voice replication, digital recording, and telephony functions. Audio subsystem 1626 can be configured to facilitate processing voice commands, voice-printing, and voice authentication, for example.

I/O subsystem 1640 can include a touch-surface controller 1642 and or other input controller(s) 1644. Touch-surface controller 1642 can be coupled to a touch-surface 1646. Touch-surface 1646 and touch-surface controller 1642 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch-surface 1646.

The other input controller(s) 1644 can be coupled to other input/control devices 1648, such as one or more buttons, rocker switches, thumb-wheel, infrared port, USB port, and or a pointer device such as a stylus. The one or more buttons (not shown) can include an up/down button for volume control of speaker 1628 and or microphone 1630.

In some implementations, a pressing of the button for a first duration can disengage a lock of touch-surface 1646; and a pressing of the button for a second duration that is longer than the first duration can turn power to user device 1600 on or off. Pressing the button for a third duration can activate a voice control, or voice command, module that enables the user to speak commands into microphone 1630 to cause the device to execute the spoken command. The user can customize a functionality of one or more of the buttons. Touch-surface 1646 can, for example, also be used to implement virtual or soft buttons and or a keyboard.

In some implementations, user device 1600 can present recorded audio and or video files, such as MP3, AAC, and MPEG files. In some implementations, user device 1600 can include the functionality of an MP3 player, such as an iPod™. User device 1600 can, therefore, include a 36-pin connector and or 8-pin connector that is compatible with the iPod. Other input/output and control devices can also be used.

Memory interface 1602 can be coupled to memory 1650. Memory 1650 can include high-speed random access memory and or non-volatile memory, such as one or more magnetic disk storage devices, one or more optical storage devices, and or flash memory (e.g., NAND, NOR). Memory 1650 can store an operating system 1652, such as Darwin, RTXC, LINUX, UNIX, OS X, Windows, or an embedded operating system such as VxWorks.

Operating system 1652 can include instructions for handling basic system services and for performing hardware dependent tasks. In some implementations, operating system 1652 can be a kernel (e.g., UNIX kernel). In some implementations, operating system 1652 can include instructions for performing voice authentication.

Memory 1650 can also store communication instructions 1654 to facilitate communicating with one or more additional devices, one or more computers and or one or more servers. Memory 1650 can include graphical user interface instructions 1656 to facilitate graphic user interface processing; sensor processing instructions 1658 to facilitate sensor-related processing and functions; phone instructions 1660 to facilitate phone-related processes and functions; electronic messaging instructions 1662 to facilitate electronic messaging-related process and functions; web browsing instructions 1664 to facilitate web browsing-related processes and functions; media processing instructions 1666 to facilitate media processing-related functions and processes; GNSS/Navigation instructions 1668 to facilitate GNSS and navigation-related processes and instructions; and or camera instructions 1670 to facilitate camera-related processes and functions.

Memory 1650 can store application (or “app”) instructions and data 1672, such as instructions for the apps described above in the context of FIGS. 1-14. Memory 1650 can also store other software instructions 1674 for various other software applications in place on device 1600.

The described features can be implemented in one or more computer programs that can be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions can include, by way of example, both general and special purpose microprocessors, and the sole processor or one of multiple processors or cores, of any kind of computer. Generally, a processor can receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computer-implemented method, performed by at least one processor, comprising:
receiving one or more documents from a user computing device, wherein the documents comprise historical and current tax return documents in a format associated with the user;
extracting one or more field-value pairs from the one or more documents via one or more natural language processing techniques;
identifying a set of relevant field-value pairs from the extracted one or more field-value pairs, wherein the identifying is performed via a feature extract process comprising predetermined knowledge of fields that are more relevant to audit risk, wherein the feature extraction process discards field-value pairs that are not relevant to audit risk;
feeding the set of relevant field-value pairs to an anomaly detection layer, the anomaly detection layer comprising a first large language model (LLM), the first LLM being finetuned to detect tax return deviation patterns and historically flagged audit patterns via historical tax return data, tax rules, and tax laws, wherein:
the first LLM has been finetuned to detect patterns that differ from previous year tax returns to the current year that increase an audit risk; and
the first LLM has been finetuned on historically flagged audit patterns and updates in tax laws and regulations;
analyzing, via the first LLM, the set of relevant field-value pairs to detect one or more historical deviation patterns associated with the user, the first LLM generating and outputting a map of the flagged deviation patterns and a supporting data for each pattern;
analyzing, via the first LLM, the set of relevant field-value pairs to detect one or more audit patterns, the first LLM generating and outputting a map of flagged audit patterns and a supporting data for each flagged pattern;
feeding the map of flagged deviation patterns and the map of flagged audit patterns and associated supporting data for each pattern to a risk score engine;
analyzing, via the risk score engine, the one or more historical deviation patterns and the one or more audit patterns comprising the map of flagged patterns to compute an audit probability associated with the received one or more documents of the user;
causing the computed audit probability to be displayed on the user device with at least one of a flagged deviation pattern and corresponding supporting data or the flagged audit pattern and corresponding supporting data;
generating and displaying to the user a natural language insight and recommendation associated with the flagged deviation patterns and corresponding supporting data or the flagged audit patterns and corresponding supporting data;
receiving, from the user computing device, a natural language user query;
re-analyzing, via the risk score engine, the audit risk using the natural language user query;
re-computing the audit probability to generate an update audit probability;
generating and displaying to the user a natural language insight and recommendation associated with the updated audit probability;
periodically accessing one or more new tax rules, tax laws, or tax data; and
periodically re-finetuning the first LLM via the accessing one or more new tax rules, tax laws, or tax data.

2. The computer-implemented method of claim 1 comprising:
analyzing, via a second LLM, the one or more historical deviation patterns, the one or more audit patterns, and the audit probability to generate one or more insights; and
causing the one or more insights to be displayed on the user device.

3. The computer-implemented method of claim 2 comprising:
analyzing, via the second LLM, the one or more historical deviation patterns, the one or more audit patterns, and the audit probability to generate one or more recommended actions; and
causing the one or more recommended actions to be displayed on the user device.

4. The computer-implemented method of claim 3 comprising:
receiving a query from the user device; and
updating at least one of the audit probability, the one or more insights, or the one or more recommended actions based on the received query.

5. The computer-implemented method of claim 1, wherein analyzing, via the first LLM, the at least one relevant field-value pair to detect the one or more historical deviation patterns comprises comparing the at least one relevant field-value pair to historical tax data associated with a user of the user device.

6. The computer-implemented method of claim 5 comprising outputting, via the first LLM, a map of at least one flagged pattern and data supporting each flagged pattern.

7. The computer-implemented method of claim 1, wherein analyzing, via the first LLM, the at least one relevant field-value pair to detect the one or more audit patterns comprises detecting the one or more audit patterns via an LLM trained on one or more of Internal Revenue Services (IRS) Guidelines, tax laws, or previously audited tax returns.

8. The computer-implemented method of claim 7 comprising outputting, via the first LLM, a map of at least one flagged pattern and data supporting each flagged pattern.

9. The computer-implemented method of claim 1, wherein identifying the at least one relevant field-value pair from the extracted one or more field-value pairs comprises identifying at least one of a field-value pair associated with an income type, a deduction, a credit, a mortgage, a loss, an itemized deductions, a crypto transaction, or a donation.

10. The computer-implemented method of claim 1, wherein analyzing the one or more historical deviation patterns and the one or more audit patterns to compute the audit probability comprises computing the audit probability via the first LLM trained on audited and non-audited tax returns.

11. A computing system comprising:
a processor; and
a non-transitory computer-readable storage device storing computer-executable instructions, the instructions when executed by the processor cause the processor to perform operations comprising:
receiving one or more documents from a user computing device, wherein the documents comprise historical and current tax return documents in a format associated with the user;
extracting one or more field-value pairs from the one or more documents via one or more natural language processing techniques;
identifying a set of relevant field-value pairs from the extracted one or more field-value pairs, wherein the identifying is performed via a feature extract process comprising predetermined knowledge of fields that are more relevant to audit risk, wherein the feature extraction process discards field-value pairs that are not relevant to audit risk;
feeding the set of relevant field-value pairs to an anomaly detection layer, the anomaly detection layer comprising a first large language model (LLM), the first LLM being finetuned to detect tax return deviation patterns and historically flagged audit patterns via historical tax return data, tax rules, and tax laws, wherein:
the first LLM has been finetuned to detect patterns that differ from previous year tax returns to the current year that increase an audit risk; and
the first LLM has been finetuned on historically flagged audit patterns and updates in tax laws and regulations;
analyzing, via the first LLM, the set of relevant field-value pairs to detect one or more historical deviation patterns associated with the user, the first LLM generating and outputting a map of the flagged deviation patterns and a supporting data for each pattern;
analyzing, via the first LLM, the set of relevant field-value pairs pair to detect one or more audit patterns, the first LLM generating and outputting a map of flagged audit patterns and a supporting data for each flagged pattern;
feeding the map of flagged deviation patterns and the map of flagged audit patterns and associated supporting data for each pattern to a risk score engine;
analyzing, via the risk score engine, the one or more historical deviation patterns and the one or more audit patterns comprising the map of flagged patterns to compute an audit probability associated with the received one or more documents of the user;
causing the computed audit probability to be displayed on the user device with at least one of a flagged deviation pattern and corresponding supporting data or the flagged audit pattern and corresponding supporting data;
generating and displaying to the user a natural language insight and recommendation associated with the flagged deviation patterns and corresponding supporting data or the flagged audit patterns and corresponding supporting data;
receiving, from the user computing device, a natural language user query;
re-analyzing, via the risk score engine, the audit risk using the natural language user query;
re-computing the audit probability to generate an update audit probability;
generating and displaying to the user a natural language insight and recommendation associated with the updated audit probability;
periodically accessing one or more new tax rules, tax laws, or tax data; and
periodically re-finetuning the first LLM via the accessing one or more new tax rules, tax laws, or tax data.

12. The computing system of claim 11, wherein the operations comprise:
analyzing, via a second LLM, the one or more historical deviation patterns, the one or more audit patterns, and the audit probability to generate one or more insights; and
causing the one or more insights to be displayed on the user device.

13. The computing system of claim 12, wherein the operations comprise:
analyzing, via the second LLM, the one or more historical deviation patterns, the one or more audit patterns, and the audit probability to generate one or more recommended actions; and
causing the one or more recommended actions to be displayed on the user device.

14. The computing system of claim 13, wherein the operations comprise:
receiving a query from the user device; and
updating at least one of the audit probability, the one or more insights, or the one or more recommended actions based on the received query.

15. The computing system of claim 11, wherein analyzing, via the first LLM, the at least one relevant field-value pair to detect the one or more historical deviation patterns comprises comparing the at least one relevant field-value pair to historical tax data associated with a user of the user device.

16. The computing system of claim 15, wherein the operations comprise outputting, via the first LLM, a map of at least one flagged pattern and data supporting each flagged pattern.

17. The computing system of claim 11, wherein analyzing, via the first LLM, the at least one relevant field-value pair to detect the one or more audit patterns comprises detecting the one or more audit patterns via an LLM trained on one or more of Internal Revenue Services (IRS) Guidelines, tax laws, or previously audited tax returns.

18. The computing system of claim 17, wherein the operations comprise outputting, via the first LLM, a map of at least one flagged pattern and data supporting each flagged pattern.

19. The computing system of claim 11, wherein identifying the at least one relevant field-value pair from the extracted one or more field-value pairs comprises identifying at least one of a field-value pair associated with an income type, a deduction, a credit, a mortgage, a loss, an itemized deductions, a crypto transaction, or a donation.

20. The computing system of claim 11, wherein analyzing the one or more historical deviation patterns and the one or more audit patterns to compute the audit probability comprises computing the audit probability via the first LLM trained on audited and non-audited tax returns.
